(19) United States
(12) Patent Application Publication
(10) Pub. No.: US 2005/0075922 A1
(43) Pub. Date: Apr. 7, 2005

(54) Influence matrix system and method

(76) Inventors: Jeffrey Brady, Jersey City, NJ (US); Kevin McMurtry, Basking Ridge, NJ (US); Greg Miller, Asbury, NJ (US)

Correspondence Address: Thomas J. McWilliams;Reed Smith LLP, 1650 Market Street, 2500 One Liberty Place, Philadelphia, PA, 19103, US

(21) Appl. No.: 10/880,353

(22) Filed: Jun. 28, 2004

Related U.S. Application Data
(60) Provisional application No. 60/482,690, filed on Jun. 26, 2003.
(60) Provisional application No. 60/506,072, filed on Sep. 24, 2003.

(51) Int. Cl. G06F 17/60

(52) U.S. Cl. 705/10

(57) ABSTRACT

The present invention includes a matrix associated with the influence of at least one participant. The matrix includes at least one participant and a market defining the practice area of the at least one participant, wherein the market is statistically modeled to represent the degree of influence exerted by the at least one participant. The present invention further includes a method of assessing an influence level of at least one physician. This method include forwarding at least two survey questions to a physician, wherein one of said at least two survey questions includes an allowance for naming at least one nominee physician, weighting at least one possible answer to the at least two survey questions, receiving at least one response to said at least two survey question, and placing the physician and the nominee physician in a referral tree at a hierarchical level in accordance with said weighting accorded the responses.

### CROSS REFERENCE TO RELATED APPLICATIONS

This application is a utility application which claims priority to U.S. Provisional Patent Application Ser. No. 60/482,690, filed Jun. 26, 2003 which is incorporated by reference, as if fully set forth in its entirety herein.

### BACKGROUND OF THE INVENTION

1. Field of the Invention

The invention relates to the field of statistical modeling, and more particularly, to modeling influence in variable markets.

2. Description of the Background

Statistical modeling of interactions between people in commerce is presently known, and is employed particularly in advertising. Statistical modeling may include a known scope approach, or an unknown scope approach and may necessitate validation of the statistical model employed.

When the underlying dynamics of a particular system are known, the analysis is straightforward, and a known scope approach may be employed. A known scope approach employs a model that is a simple modification of well established laws or equations, such as by the insertion of variables or well known variations to particular physical laws.

An unknown scope approach is employed when the precise mathematical modeling or variation to comport with real world activities are unknown. The underlying nature of an unknown scope system is outside the present understanding in the particular art. As such, there is no existing or known equation to develop a model in an unknown scope system. Thus, in such a model, the modeler attempts to assess the circumstances, the environment, and the observed behavior of a system, and tries to estimate those factors and the underlying dynamics by drawing on equations generally employed in the known scope approach. However, in the unknown scope approach, such modeling is inexact, as flaws and observations were noise within a study, may add additional degrees of freedom not captured by the approximation model.

Hence, both known scope and particularly unknown scope approaches to statistical modeling may be well served by validation. Validation of a model is an experimental attempt to insure that the model captures the actual behavior of a system. A model is generally unsuitable for use in prediction, analysis, or manipulation of a system until the model has been validated. Once a model has been validated, the model may serve as a substitute for the actual system, and may allow analysts to determine the effects of changes in the system without the effects actually taking place.

In the known art, the influence of particular people on systems in commerce is desirable to be known. However, before the actual implementation of such influence, the influence must be subject to the unknown scope approach. Presently, the unknown scope approach with regards to the influence of physicians in the pharmaceutical industry is subject to an unknown scope approach employing a limited set of variables. These variables include principally the number of prescriptions written by particular physicians, and the assessment of opinion from local sales representatives for pharmaceuticals. Further, this unknown scope approach presently employs, for the most part, random sampling of only a very limited number of respondents to assess the influence within the system. Such an unknown scope approach fails to account for the myriad of variables present in an influence system in the pharmaceutical industry, and hence the present modeling is statically inappropriate for prediction of physician influence. Thus, the need exists for a system, device, and method that provides statically accurate modeling and an approved unknown scope approach to influence in the pharmaceutical and like industries.

### SUMMARY OF THE INVENTION

The present invention includes a matrix associated with the influence of at least one participant. The matrix includes at least one participant and a market defining the practice area of the at least one participant, wherein the market is statistically modeled to represent the degree of influence exerted by the at least one participant.

The present invention further includes a method of assessing an influence level of at least one physician. This method include forwarding at least two survey questions to a physician, wherein one of said at least two survey questions includes an allowance for naming at least one nominee physician, weighting at least one possible answer to the at least two survey questions, receiving at least one response to said at least two survey question, and placing the physician and the nominee physician in a referral tree at a hierarchical level in accordance with said weighting accorded the responses.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an influence matrix suitable for determining key physicians in a localized market according to an aspect of the present invention;

FIG. 2 illustrates an implementation of an administration module of the influence matrix of FIG. 1;

FIG. 3 illustrates a project list of FIG. 2 according to an aspect of the present invention;

FIG. 4 illustrates a project properties window display according to an aspect of the present invention;

FIG. 5 illustrates a target list window suitable for access to a list of targets or survey according to an aspect of the present invention;

FIG. 6 illustrates a search window for searching target listed in the illustration of FIG. 5;

FIG. 7 illustrates results responsive to a target search in the window illustrate din FIG. 6;

FIG. 8 illustrates a project survey data window that provides the record keeping module for an influence matrix according to an aspect of the present invention;

FIG. 9 illustrates the personal information window of a selected target according to an aspect of the present invention;

FIG. 10 illustrates the window for the addition of question responses according to an aspect of the present invention;

FIG. 11 illustrates the window for the addition and editing of referrals according to an aspect of the present invention;

FIG. 12 illustrates a window displayed showing a referral returned from a search according to an aspect of the present invention;

FIG. 13 illustrates the window used to add a referral according to an aspect of the present invention;

FIG. 14 illustrates a confirmation window may be displayed in order for the user to confirm the desire to add or edit a person to the system through the referral mechanism according to an aspect of the present invention;

FIG. 15 illustrates a selectable project person referral window according to an aspect of the present invention;

FIG. 16 illustrates the automatic personalized thank you letter generated according to an aspect of the present invention;

FIG. 17 illustrates a system usage report according to an aspect of the present invention;

FIG. 18 illustrates the features associates with administrative access of surveys, survey questions, referral types, and other influence matrix data and documentation;

FIG. 19 illustrates the survey properties display for edit according to the window of FIG. 18;

FIG. 20 illustrates the addition or questions or modification of existing question window according to an aspect of the present invention;

FIG. 21 illustrates an available answer list provided responsive to the survey question property type according to an aspect of the present invention;

FIG. 22 illustrates a window with an available answer list applicable to each available answer;

FIG. 23 illustrates a window for editing specific survey questions according to an aspect of the present invention;

FIG. 24 illustrates the survey question properties window accessible through the window of FIG. 23;

FIGS. 25 and 26 illustrate additional windows accessible through the editing of the answer list according to an aspect of the present invention;

FIG. 27 illustrates the window for deleting survey questions;

FIG. 28 illustrates the window for adding referral types according to an aspect of the present invention;

FIG. 29 illustrates the window for editing referral types according to an aspect of the present invention;

FIG. 30 illustrates the window for loading referral types according to an aspect of the present invention;

FIG. 31 illustrates the window for editing document templates for use in correspondence with professionals, such as clients, targets and respondents according to an aspect of the present invention;

FIG. 32 illustrates the display of a document for editing including highlighted portions that may be edited and/or automatically added by the system;

FIG. 33 illustrates the logging in window for accessing the influence matrix reporting according to an aspect of the present invention;

FIG. 34 illustrates the influence matrix project list for the logged in party;

FIG. 35 illustrates an influence matrix summary report;

FIG. 36 illustrates a survey question summary;

FIG. 37 illustrates a target mailing list according to an aspect of the present invention;

FIG. 38 illustrates referrals submitted by the target according to an overall rating;

FIG. 39 illustrates a list of names available for a nominee according to an aspect of the present invention;

FIG. 40 illustrates an ordered list according to an aspect of the present invention

FIG. 41 illustrates the target nominee's window selected via a target hyperlink according to an aspect of the present invention;

FIG. 42 illustrates a referral tree associated with a name;

FIG. 43 illustrates a nominee list according to an aspect of the present invention;

FIG. 44 illustrates a relationship tree according to an aspect of the present invention;

FIG. 45 illustrates a unique nominee list according to an aspect of the present invention; and

FIG. 46 illustrates a referral tree for a unique nominee of FIG. 45, according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical influence modeling systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

An influence matrix is a matrix that may be used to determine key participants, and the influence of those key participants in a predetermined market, such as, for example, physicians in a local pharmaceutical market. An influence matrix may use statistical modeling to create a model of the participants in a local market, and the degree of influence exerted by those participants in that market. Thereby, an influence matrix may result in a comprehensive picture of market influence. For example, in an exemplary pharmaceutical environment, the actual “pharmaceutical influence” of physicians in a network of local physicians may be assessed. The statistical model employed to assess influence may be any statistical model apparent to those skilled in the art, such as weighted survey responses.

The weighting of survey responses, for example, may assign ratings and may generate the referral tree of an influencer responding to the survey. A referral tree may illustrate the levels and extent of influence of that participant in a given market, and thereby may provide pharmaceutical sales representatives with a scientifically accurate view of a local market, for example. Thereby, key participants may be identified based on a statistical influence model that relies on multiple factors, rather than reliance on a single factor as was used in the prior art. Such single factors have historically included the number of prescriptions written by a physician, or a sale representative's assessment or opinion of the influence of a particular physician on other physicians. Thus, an influence matrix may provide a company, such as a pharmaceutical company, with scientifically valid and supported data to employ in sales and marketing programs. This valid and statistically supportable data may allow clients to enter unexplored markets, such as by endeavoring to sell a particular drug to physicians who are not yet currently prescribing that particular drug, and additionally may allow clients to utilize existing advocates to sell in unexplored markets, such as advocates including physicians who may be currently prescribing the particular drug.

The influence mapping into the influence matrix in the present invention may be based on multiple factors, wherein each factor may be weighted to provide a true influence assessment, and as such, may provide improvement over single factor samples or established random sampling from a target list in the prior art. Multiple factors may, for example, be entered into a relational database to select the most influential participants in markets desired for viewing by a user of the relational database, such as a local pharmaceutical market.

The multiple factors used in an influence matrix may identify key groups of opinion leaders, such as local opinion leaders who may be identified by customers and targets as being respected and influential to their peers, and super-influencers who may be identified by local opinion leaders (LOL) as being the most expert and knowledgeable peers in a particular geographic region or sales area.

Thus, the multiple factors may assess using at least two types of information, namely client supplied information, such as from clients in receipt of at least one survey about frequently prescribing and targeted physicians, and survey response information from targeted physicians regarding persons those targeted physicians perceive as influential and/or trustworthy. Thus, questions in a survey may be designed by a surveyor, but may include survey questions unique to the particular influence to be assessed, such as numbers of prescriptions written by each physician, and types of prescriptions written by each physician. Thereby, targeted responses may show those persons the targeted physician respect, and to whom the targeted physicians refer patients, and thus targeted physician surveys may additionally be directed to assessing referrals, prescriptions written by the target and those to whom the target refers, and the like.

An influence matrix may record and map the responses of the targeted physicians, and those the targeted physicians consider to be influential, in a relational database or like recordation tool. The influence matrix, by capturing responses, may additionally capture links between surveyed physicians, targets, nominees, and additional survey mechanisms. This capturing of links may allow for the creation of the final influence matrix for a selected area or region, and such an influence matrix may evidence an influence tree for any selected party participating in the survey or named in the survey, in light of client responses and target physician responses. The relationship tree may show all relationships among LOLs and targeted responses in a selected marketplace, or cross marketplaces.

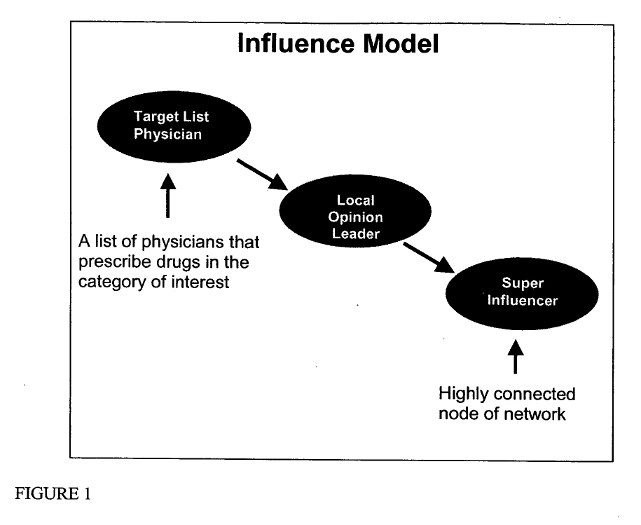

As illustrated in FIG. 1, an influence matrix may determine key physicians in a localized market. The influence matrix may be based on statistical modeling and may result in a comprehensive picture of actual influence, such as pharmaceutical influence, in a network of physicians. The statistical modeling used may be based on, for example, weighted survey responses.

Any nominees or party selected from within the influence matrix may be viewed by that nominee's referral tree. A referral tree may provide, in an format known in the art, a hierarchy tree of the influence of the party selected.

Influence information may be available to allow for targeted sales or marketing programs. It may allow pharmaceutical clients to enter unexplored markets, or to utilize existing advocates to expand in current markets or expand into those unexplored markets.

An influence matrix may include at least two types of information, for example. It may capture pharmaceutical client supplied information regarding frequent subscribers of a particular drug, and/or targeted physicians who the pharmaceutical client would like to prescribe a drug. Additionally, as survey responses are returned, an influence matrix may include information obtained from targeted physicians who are in receipt of the survey, such as information regarding who those physicians perceive as influential and trustworthy. Such survey responses may include information on the most respected physicians, or to whom patients are most often referred. Respected and influential targets may be assessed as local opinion leaders (LOL). The most expert, knowledgeable, and respected physicians in a particular selected region or area may qualify as super influencers (SI). The influence matrix may illustrate the relationships between targets, LOLs and SIs.

As used herein, local pharmaceutical opinion leaders, a subset of LOLs, may include healthcare professionals having a wide network of influence in the pharmaceutical area. In accordance with an influence matrix, it has been assessed that local opinion leaders and pharmaceuticals are rarely the highest pharmaceutical prescribers. Generally, it has been found that 75% of healthcare professionals nominated as LOLs are not included on the high prescriber list. This finding is based on more than 50,000 survey responses.

LOLs are often academic or hospital based professionals, and hence may not necessarily prescribe high volumes of pharmaceutical products. Thus, the influence matrix of the present invention is unique in that it may allow a targeting of actual LOLs, rather than the high prescribers previously perceived as LOLs.

SIs may be assessed as the strongest LOL candidates, or may be assessed in separate influence matrixes from the LOLs. As a network develops, SIs may develop as the most connected candidates throughout a particular selected network. The most connected candidates may have more direct and indirect referrals, and higher ratings, then the typical targets. For example, an influence matrix may include secondary or tertiary surveys of those found to be LOLs in order to identify the SIs. The connection between LOLs, and SIs and LOLs may significantly impact the understanding of influence in a community, as well as the manner in which information and knowledge may be transmitted.

An influence matrix in accordance with the present invention is preferably provided in software, such as software available over a network, such as the internet or an intranet or extranet. Thus, clients, and/or targets, may have continuous 24 hour 7 day per week access to results and/or information regarding results, such as survey results. The influence matrix may be made available in any suitable format, such as a tree format, a database format, such as MicroSoft Excel, a drop down menu format, or the like. The influence matrix may be stored remotely from the client in one or more servers for a period of time, such as for weeks, months, or years after surveys are completed. Data may be retrievable over the course of history of data tracking, such as for one survey, for a set amount of time, such as weeks, months, or years. This may allow for follow-up surveys to initial influence matrixes as well as add-on surveys or surveys for nearby or associated geographies, regions, networks, or areas. An influence matrix may be sorted by market, area, region, geography, prescription type, physician type, or the like. Thus, influence matrix data may be sorted or presented in accordance with the selection by a user, such as a selected physician type, a selected region, or a selected nation. An influence matrix may be linked to the target for events, such as education events, or continuing education, for example.

Data formatting in the present invention may be due, in part, to the statistic modeling or calculations used. For example, a client may generate a survey and accord a particular weight to each response on the survey. The responses of each respondent to the survey may then be scored for each question answered, and a total score may be generated. The total score may then be illustrative of the influence of the respondent to the survey.

Of course it will be apparent to those skilled in the art that any dynamic mathematical modeling system may be used to generate an influence matrix. An accurate model of a particular type of influence may be difficult to obtain due to incomplete data, noisy observation, or neglected variables, for example. Thus, statistical modeling may be used to generate an influence matrix. A statistical model may average out noise observations and may account for neglected variables. In fact, multiple models may be employed, in order to average out inconsistencies among individual models.

A statistic validation model employed in the present invention may represent each individual in a network as a node in the network, and each interaction of interest between individuals, or nodes, in the network as a connection. Thus, information in the network flows between nodes and over connections. Data collection may define the position of the nodes within the network. The nodes may be, of course, physicians within the network. Once the data collection has been performed through the use of surveys, a diverse governing equation may be employed to define the connections between the nodes described in the survey responses. The model may be validated when the nodes and connections generated are compared to actual observed data through the network. A probabilistic approach may be used to mimic the actual behavior of nodes and connections in a statistical system. Data obtained through an artificial pseudo network may be compared against actual data obtained through surveys. Additionally, if the pseudo network proves correct or substantially correct for a given model, the pseudo network may serve to fill in missing details or filter noise in the data collection phase.

With respect to the influence matrix of the present invention, nodes of interest may include physician and physician referral names returned in each survey. An initial influence matrix may generate probabilistic outcomes for the expected initial conditions of the connections between the expected nodes in the network.

Individual nodes within the network may include a myriad of useful information, only certain of which is necessary for the influence matrix. Such relevant information may be extracted by any known search mechanism, wherein relevant information includes information desired for response in the survey in order to access influence. Other information may be stored for future or subsequent use, such as in other surveys. In fact, stored information may be used to generate probabilistic results in a pseudo network for the initial influence matrix in a subsequent survey. Ratings for individual nodes in the network, as discussed hereinabove, may be represented by the sum of the weighted values of the responses to survey questions.

Survey questions may eliminate reliance on bias or anecdotal evidence. Such bias or anecdotal evidence may frequently be evidenced in the initial probabilistic model of the expected survey results. However, the final influence matrix may frequently be generated such that it is distinctly different from the initial probabilistic matrix. Further, the receipt of additional data, traits and weightings may allow for modeling of subsequent probabilistic matrixes. Further still, unexpected or additional node types may be generated in addition to those assessed in the initial probabilistic matrix.

The results of an influence matrix may be tested, such as against observed data or initial probabilistic models. For example, a group of physicians may be randomly selected and compared to the pattern and extent of influence assessed in the influence matrix, such as using observed influence in the form of referrals, for example. In such a test, if, for example, it was found that SIs did not differ statistically in influence from a random selection on the target list, it may be clear that the initial probabilistic model was incorrect, and that the influence matrix based on the assumptions of the initial probabilistic matrix may also be incorrect.

SIs may be critical nodes within the network. Thus, it may be important that the initial probabilistic modeling, and the final influence matrix, properly classify SIs. In order to improve proper classifications of SIs, the referral tree discussed hereinabove may be color coded to graphically show the strength of relationships, and the statistical significance of relationships, for an SI or other entity within an influence matrix. Such a referral tree may be compared against a high prescriber tree, since high prescribing data may also be added to the influence matrix in order to assess whether a classified SI is an actual SI, or merely a high prescriber.

The data obtained in both the probabilistic and final influence matrixes may be filtered by various methods, including statistical methods, apparent to those skilled in the art. Additionally, such filters may be added or removed from an influence matrix in order to better fit survey data obtained with actual data observed. Similarly, weighting may be added or varied in an influence matrix in order to obtain more significant results. Weights may be assigned to any desired category, number of categories, or specific traits in an influence matrix. For example, traits assigned particular weights may include the volume of prescription writing, the number of patient exposures, partners in a practice configuration, interns from academic exposure, papers published in academic participation, advertising and extent of practice exposure or participation in conferences, for example. Weighting may take the form of a coefficient assigned to one or more such traits responsive to a survey question.

In an exemplary illustration hereinbelow an influence matrix generation may include an administration module and a reporting module, for example. Administration may be restricted to particular internal users. Reporting may be accessible to an administrator, a client such as through a client portal, a target, or the like. Accessibility to administration or reporting modules may be controlled, for example, by software security, network security, log-ins, inactivity time outs, or the like.

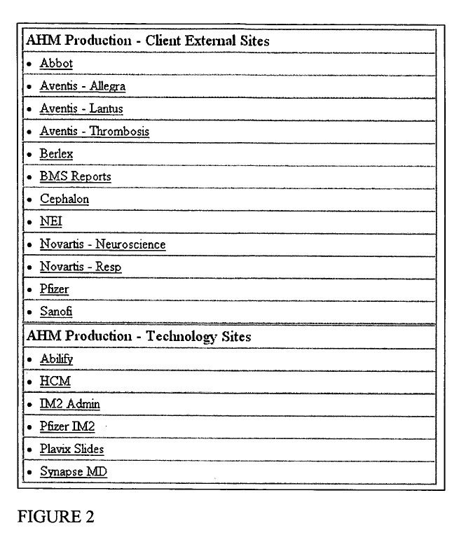

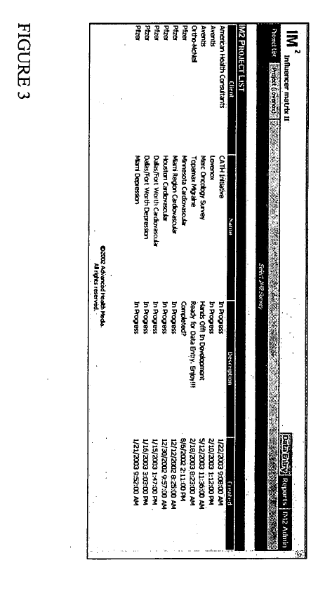

FIG. 2 illustrates an implementation of an administration module that includes survey set-up and data entry performed as surveys are returned. Administrative functionality may, in some embodiments, not be provided to clients such as pharmaceutical clients or targets. Survey data entry may be automated, such as by electronic methodologies, or manual, as will be apparent to those skilled in the art. The administration menu may provide access through a project list, as illustrated in FIG. 2. The project list, and all such lists, may be accessible in the present invention by methodologies known to those skilled in the art, such as via menus or hyperlinks. A project list is illustrated in FIG. 3. The project list may display existing projects for a specific selected client or clients, for example. Surveys may be listed in the project list by client. Surveys may be displayed in the project list as hyperlinks, for example, in order to allow access to submenus within each survey. Notes related to the client, status, state, or the like may also be included in association with each project. A last viewed project from the project list may also be displayed for easy access in a readily accessible point in the project list window.

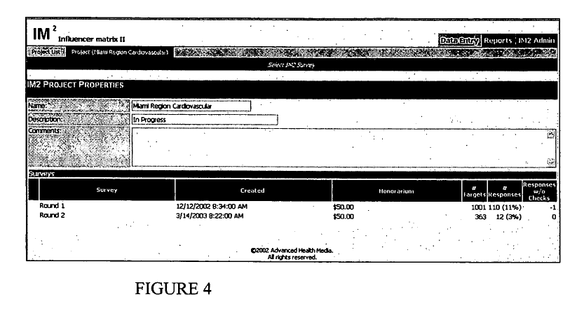

If a hyperlinked project name is selected, project properties and access to survey data with regard to the project, maybe provided. A project properties window display is illustrated in FIG. 4. The name, description, comments, and the like fields displayed in the project properties window may be editable or not editable. For the selected project, information may include current surveys with dates, pre-set honoraria, total targets, total respondents, and number of respondents with or without checks, for example. Targets, as used herein, may refer to a physician or other medical professional, to whom a survey was sent. Respondents refers to targets who have completed and returned a survey. The value listed in honoraria may reflect a standard amount that is paid to each target who becomes a respondent.

Each current outstanding or completed survey may be displayed in the project properties window of FIG. 4. For each survey, be it a first round, second round, or combined survey, the total number of surveyed targets may be displayed, the total number of respondents may be displayed and the number of respondents with or without checks, may be displayed. Round one, as used herein, may refer to an initial survey of targets. A second round survey may be administered to unique nominees identified through a first survey round, and first and second rounds may be combined as discussed hereinabove with the assessment of LOLs and SIs.

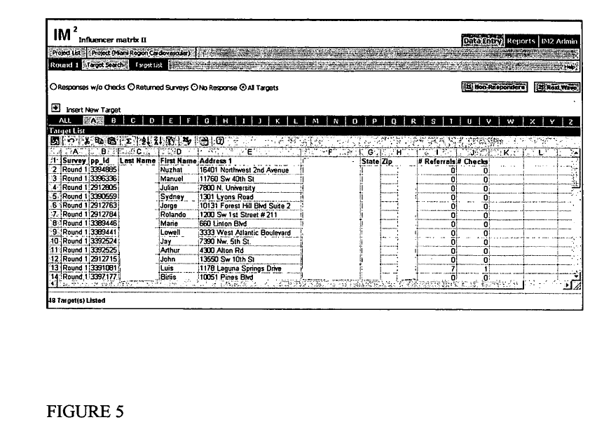

As illustrated in FIG. 5 a target list window may allow access to a list of targets or survey. The target list may be sorted in any manner apparent to those skilled in the art, such as alphabetically by last name. The target list may be resorted as desired. New targets may be added to the target list. Such new targets may include those receiving surveys who are not on the initial survey list. For example, a targeted physician may give the survey to an associate physician. Thus, the associate physician may be inserted as a new target. This may be performed by clicking add new person place, for example.

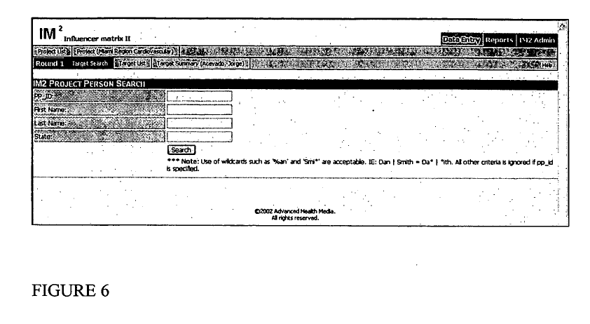

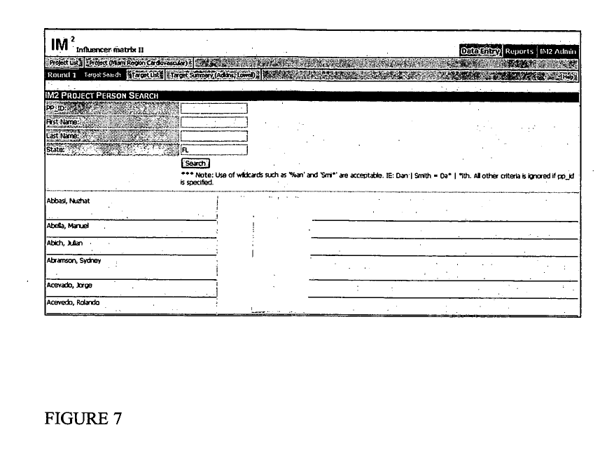

As illustrated in FIG. 6, targets may be searched. Targets may be searched by a particular identification code such as a person place identification code assigned by a planning system, such as a planning software system. Alternatively, targets may be searched by name, practice type, area, geographic region, network, insurance, or the like. FIG. 7 illustrates results responsive to a target search. Individual target names may be displayed as hyperlinks that allow access to a target summary window which may include target summary information for that particular target.

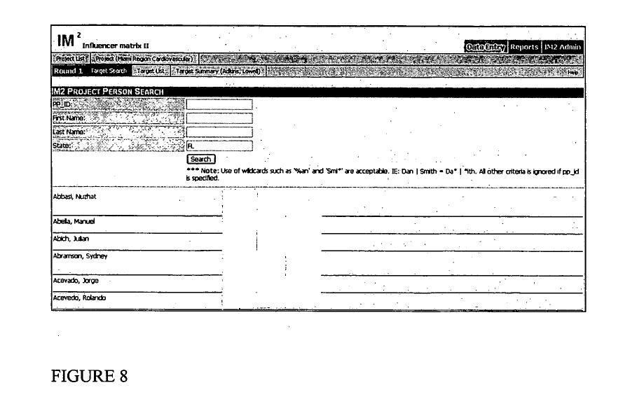

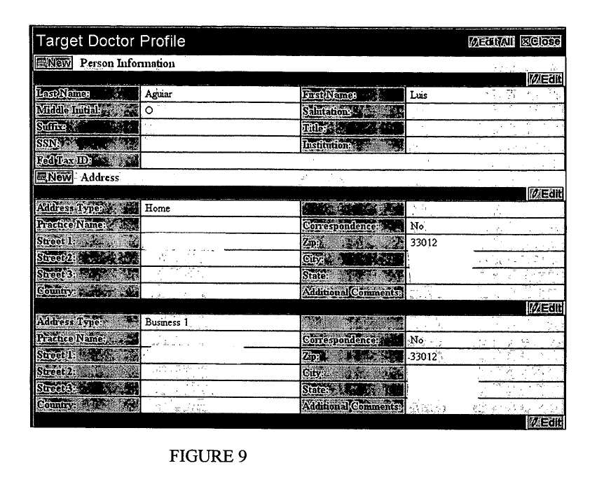

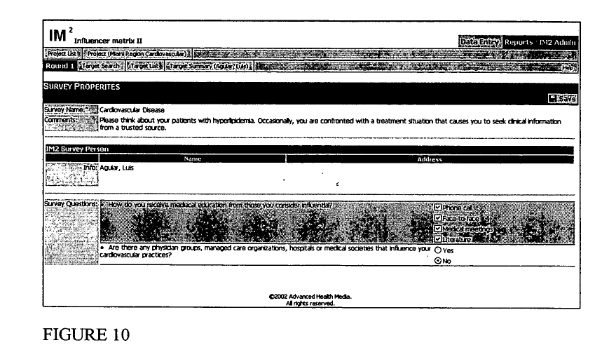

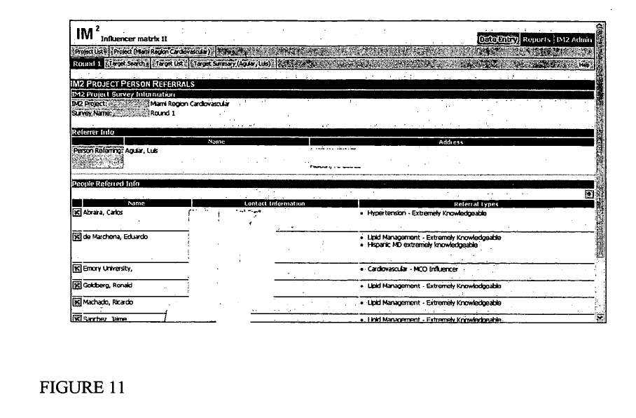

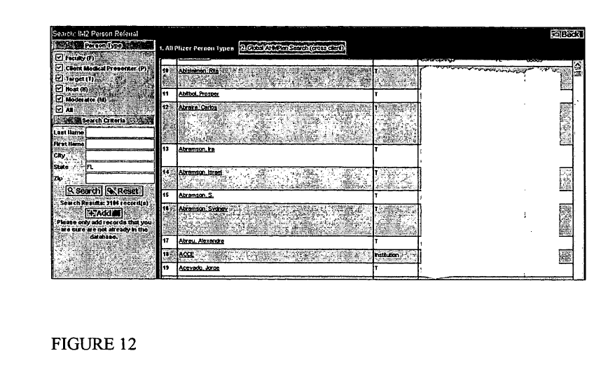

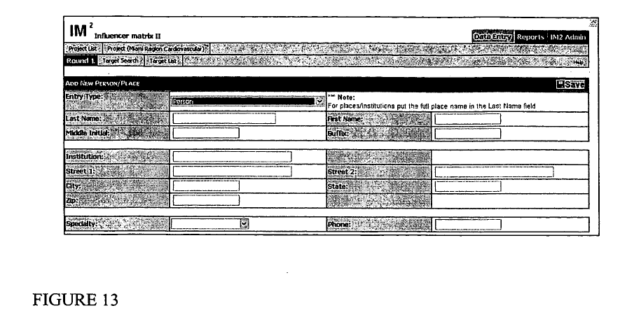

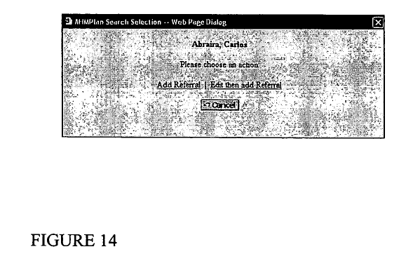

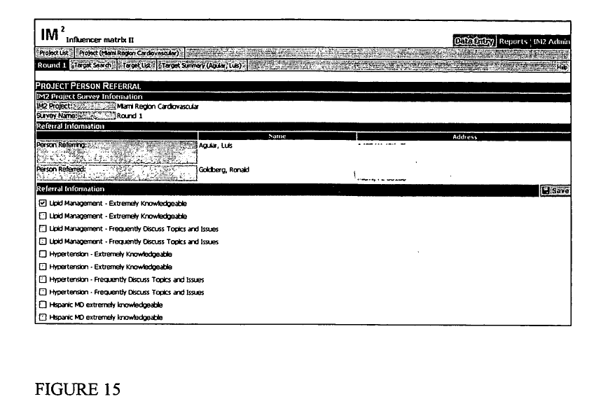

FIG. 8 illustrates a project survey data window that provides the recordkeeping module for an influence matrix. The survey data window may be accessed by accessing a target from the target search result or target list window. From the survey data window, a user may update a target profile, record responses, record referrals, record payments, such as honoraria payments, or initiate fulfillment tasks, for example. For example, FIG. 9 illustrates the personal information of a selected target. From FIG. 9 a user may update the profile information of that target. FIG. 10 illustrates the addition of question responses. From this window, responses may be entered, added, or edited. FIG. 11 illustrates the addition and editing of referrals. Referrals provided by targeted respondents provide priority connections in the influence matrix. These referrals responsive to survey questions may be added or edited as shown in FIG. 11. A new referral may already be resident in the influence matrix system, and if the referral is already present, the referral may be returned by searching for the referral, as shown in FIG. 12. If the search does not return the referral, the referral party may be added and thus may be returned in later searches through the influence matrix system. Such a referral search is illustrated in FIG. 12. The addition of a referral is illustrated in FIG. 13. In order to prevent undesired data modification, a confirmation window may be displayed in order for the user to confirm the desire to add or edit a person to the system through the referral mechanism. Such a confirmation window is illustrated in FIG. 14. A selectable project person referral window is illustrated in FIG. 15. As is shown in FIG. 15, referral information may include both the person referring, and the person referred. All entered names may then be hyperlinked to various other windows throughout the influence matrix system. Comments with regard to each referral may additionally be entered by the user.

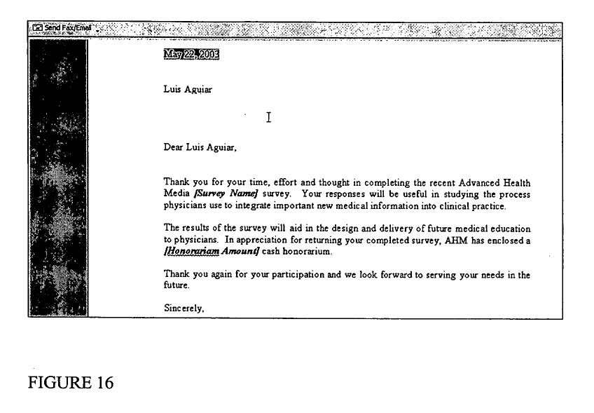

Target physicians may be paid an honoraria when a survey is returned. After survey results are recorded, the system may automatically generate an honoraria check and print a thank you personalized to the targeted respondent. Further, the status of a honoraria check may be tracked by check status, check number, amount, or request date, for example. Additionally a check may be added to the system for generation if none is generated automatically. Honoraria expenses, and associated expenses, such as postage, may be tracked by the influence matrix system. Further, the automatic personalized thank you letter may be generated manually, or the automatic letter may be edited by a user prior to generation. This is illustrated in FIG. 16.

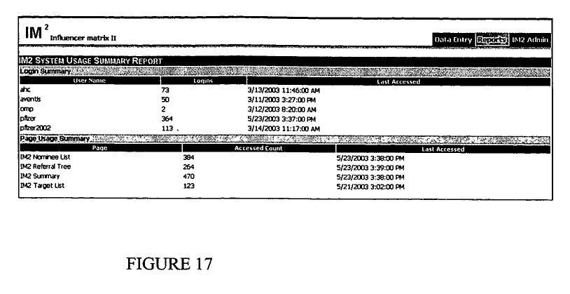

The administration portion of the influence matrix system may additionally allow for a monitoring of system usage. A system usage report may be is selectable and is as illustrated in FIG. 17.

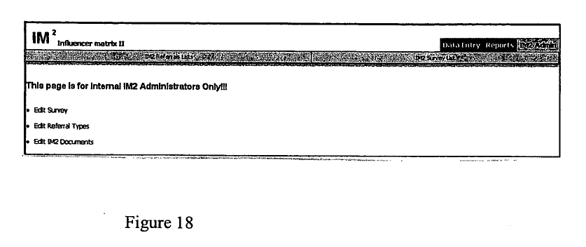

A user with administrative access may edit surveys, survey questions, referral types, and other influence matrix data and documentation. Such access may be provided as illustrated in FIG. 18.

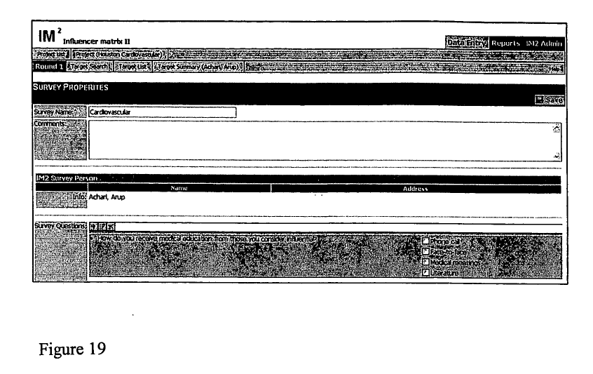

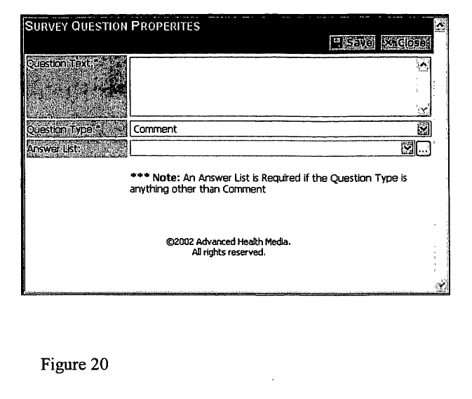

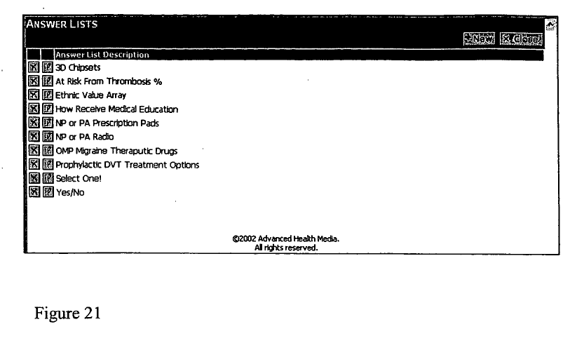

In order to edit or add survey questions, the edit survey may be selected, as is shown in FIG. 18. The survey properties may then be displayed, as illustrated in FIG. 19. The survey properties may be added or edited as is shown in FIG. 19. For example, new questions may be added to an existing survey, or properties of existing questions may be varied. The variation of existing survey questions is illustrated in FIG. 20. For example, question properties may include the type of question, and hence the response anticipated. For example, a question type may include a question that requires a responsive comment, multi-select with check boxes, multi-select check boxes with comments, a single select drop down, a single select radial, a single select with comments, drop down or radial, text input, or value array. In certain embodiments, such as multi-select, available responses may also be provided responsive to the survey question property type. An example of such an available answer list is illustrated in FIG. 21.

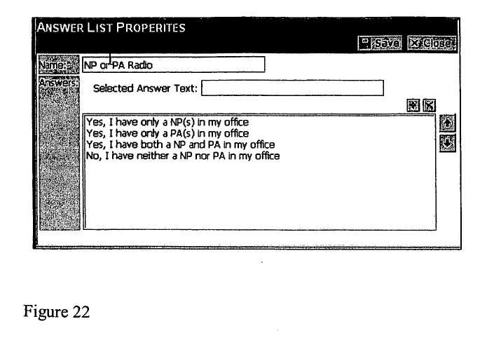

An available answer list may provide properties applicable to each available answer, as is illustrated in FIG. 22. Desired answer list properties may be limited to those presented, or may be editable in certain embodiments.

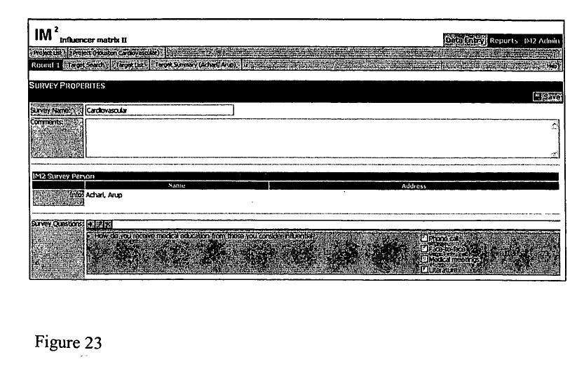

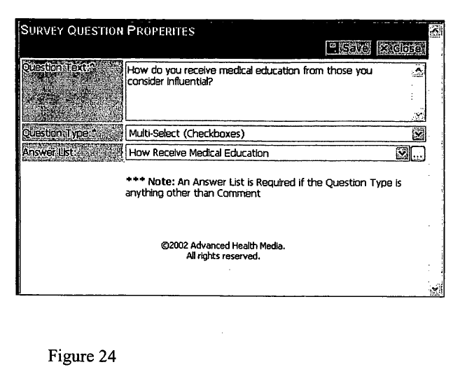

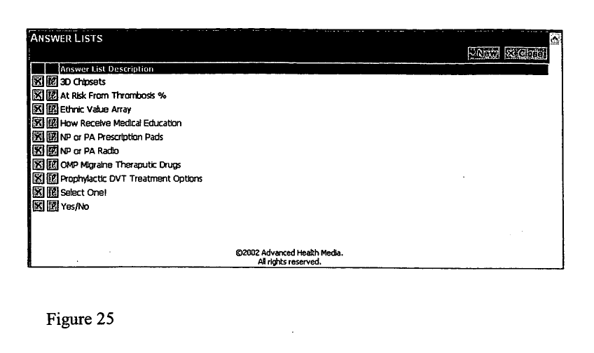

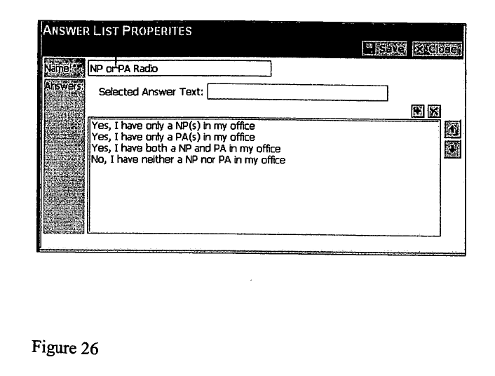

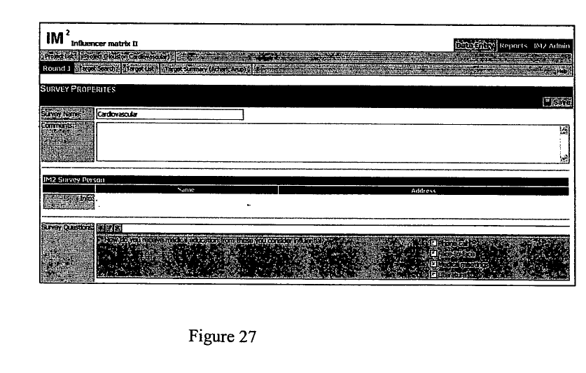

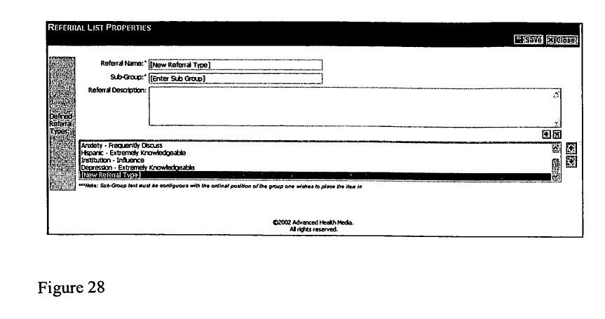

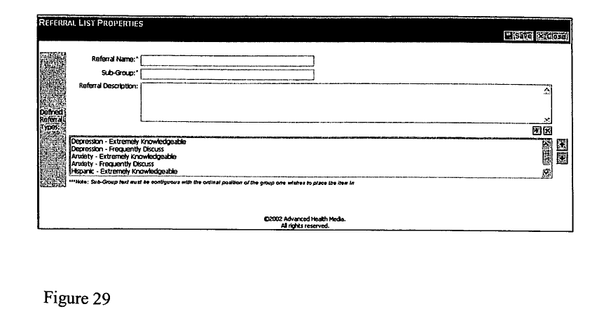

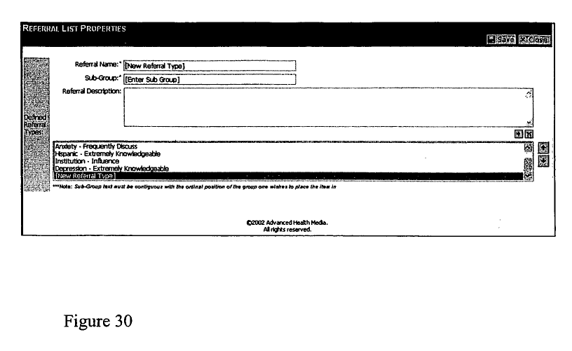

Specific survey questions may be edited, as discussed hereinabove. The editing of such questions is illustrated at FIG. 23. For example, the edit button beside the survey question desired to be edited may be selected in order to update the existing question. The survey question properties window may then be displayed, as illustrated in FIG. 24. From FIG. 24, the question text, question type, or answer list may be edited. The editing of the answer list may bring up additional windows, such as those illustrated in FIGS. 25 and 26. Survey questions may be deleted, as illustrated in FIG. 27. Referral types may be added as illustrated in FIG. 28, or edited, as illustrated in FIG. 29. Referral types may be selectable only from a predefined set of selections or may be entered by a user in text format, for example. Referral types, similarly to question types, may also be organized by groups and sub-groups, for example wherein groups and sub-groups are selectable in, for example, drill down menus. Referral types may be leaded, as illustrated in FIG. 30.

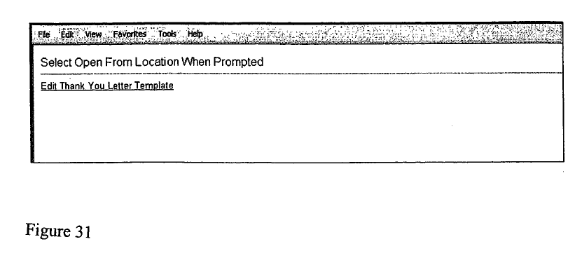

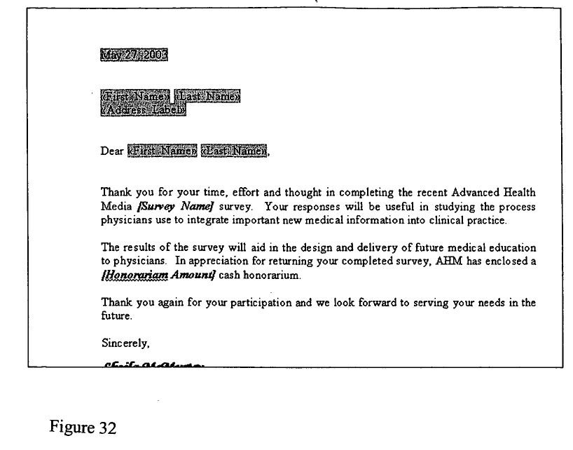

The influence matrix system may allow for document templates for use in correspondence with professionals, such as clients, targets and respondents. Such documents may be edited from within the influence matrix system. An example of the editing of such a document is illustrated in FIG. 31. The selection of a template in FIG. 31 for editing may bring up the document associated with the template, with portions highlighted that may be edited and/or automatically added by the system. An example of the display of the document associated with the template is illustrated, in FIG. 32.

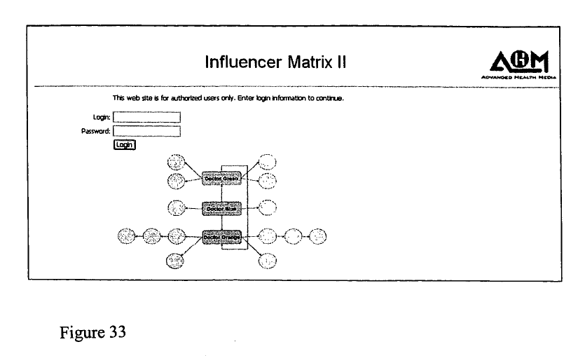

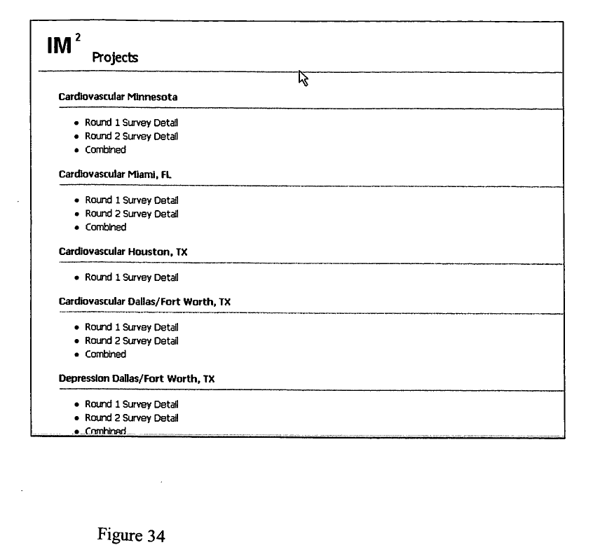

As survey responses are received and survey data is entered, the influence matrix may be mapped, and thereby relationships in the form of connections between nodes may be generated. The relationships generated may be accessible through the reporting module of the influence matrix. The reporting module may be available to the client who requested the initial survey, and, in some cases, may be available to targets of the survey. The influence matrix reporting may be obtaining such as by the client, by logging in to a log in window as illustrated in FIG. 33. Upon successful log in, the influence matrix project list for the logged in party may be displayed, as illustrated in FIG. 34. The project list may include each project and each project may have associated therewith a round one survey, a round two survey and/or combined results surveys, as discussed hereinabove. A hyperlinked survey may be accessed in order to display the influence matrix associated with that survey.

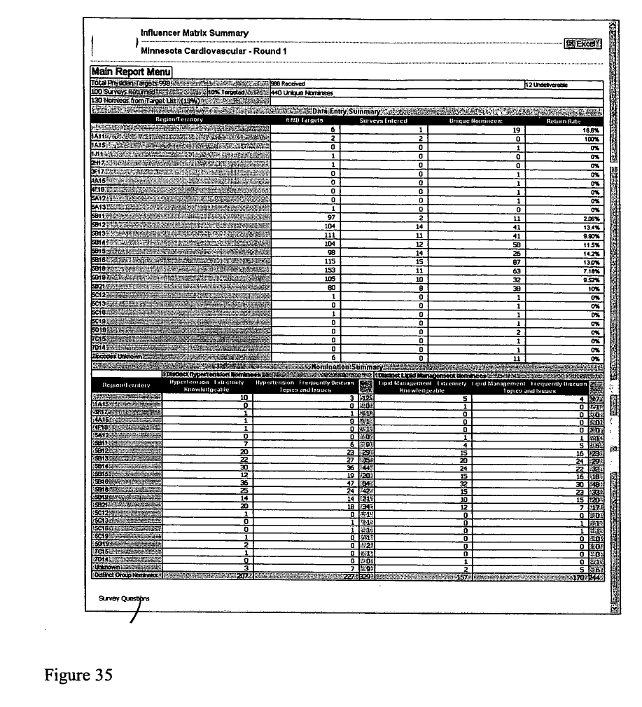

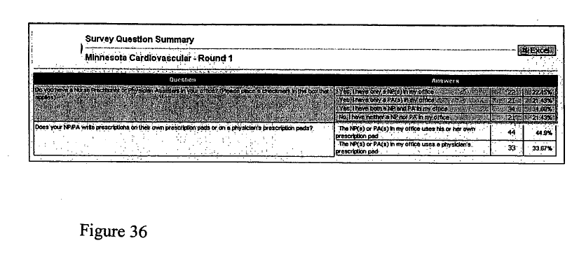

Accessing of the survey may present the influence matrix summary report for the selected survey. The influence matrix summary report is the main report for all survey data with respect to the selected survey. It may include tables, graphs, and/or results and may provide a view of survey results and related links. The influence matrix summary report may show the total number of targets, the number of respondents, the number of unique nominations, the number of nominations from the existing target list, and the like. Selection of the hyperlinks associated with any of these categories may provide access to a list of individuals falling in each category. An example of the influence matrix summary report is illustrate in FIG. 35. The summary report may provide access to data on the target number, return surveys, unique nominations, and return rate according to, for example, a selected region or territory or market type. The influence matrix summary may additionally provide access to a survey question summary associated with a particular survey summarized in the influence matrix summary. Such a survey question summary is illustrated in FIG. 36. The summary may provide the survey questions, the possible answers to the survey questions and the number of responses and percentage for each answer to the survey questions.

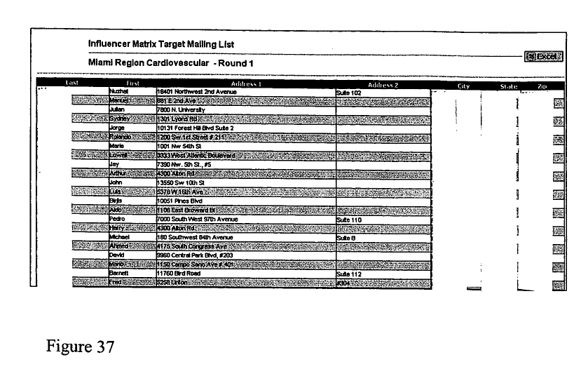

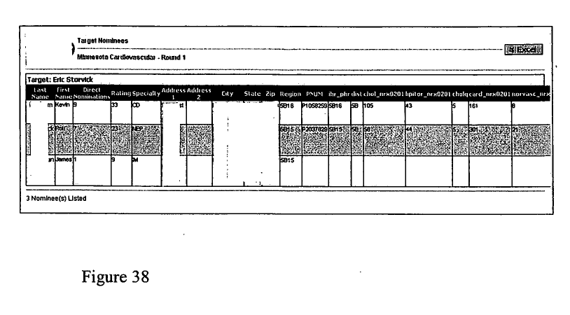

Referral trees may additionally be accessible from the influence matrix summary. Referral trees may provide a graphical representation of the influence matrix results. The graphical illustration may include nominees and each referring target, as well as whether the referring target is primary, secondary, or tertiary. For example, all target positions may be viewed in the present invention. The target mailing list may be ordered in any manner known to those skilled in the art, and may appear as illustrated in FIG. 37. Clicking a hyperlinked name as is shown in FIG. 37 may display the target nominees window. From this window, illustrated in FIG. 38, the referrals, if any submitted by the target may be viewed according to an overall rating. The window of FIG. 38 may display all physicians nominated by the selected target. It also may list the total survey information for the particular nominee, including the total number of direct nominations including the selected target, the overall rating based on primary, secondary and tertiary nominations, particular specialty, contact information, or specific knowledge or demographic information supplied by the nominating target. The total number of direct nominations may refer to the number of target physicians who nominated the particular selected individual. The rating may be a more specific ranking system based on the number of direct versus secondary and tertiary nominations. Direct, or primary, nominations occur when a target physician directly nominates another physician by name. A direct nomination may be assigned a particular value, such as 3, in the ranking system. Secondary and tertiary nominations occur when a target nominates a physician who, in turn, nominates another physician, hence making the other physician the indirect nominee. A secondary nomination may have a particular value, such as 2, and a tertiary nomination may have a particular value, such as 1, within the rating system. High ratings and rankings may identify LOLs. The criteria to qualify as a high rating may be subjective, and may be selected by a particular client. Generally, LOLs may be required to have ratings of a significant percent higher than an average rating.

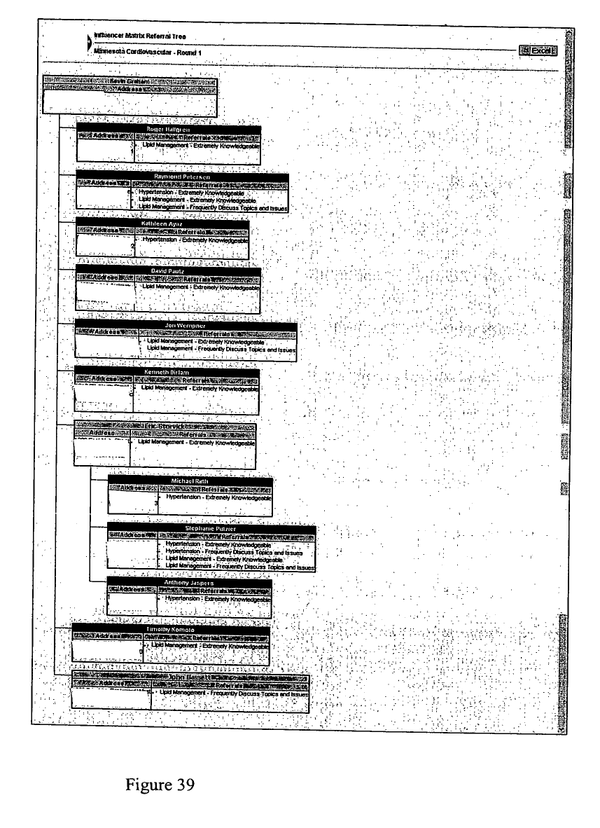

A hyperlinked nominee, such as a last name, may be selected in order to view a nominee relationship tree for that nominee. The nominee selected may be viewed at the top of such a window. The names listed below in the window may refer to people who named this particular nominee on their survey. Such a window is illustrated in FIG. 39. The referral tree of FIG. 39 may visually demonstrate relationships between the nominee, and direct, secondary, and tertiary referring targets. The referral tree may additionally indicate whether a person in the tree was in the original target list, and/or was also nominated by someone else responding to the survey.

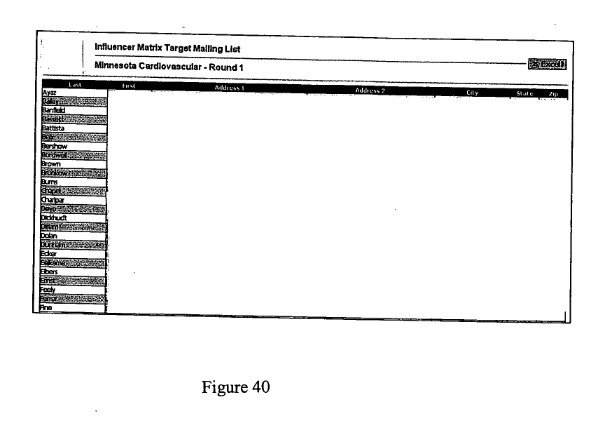

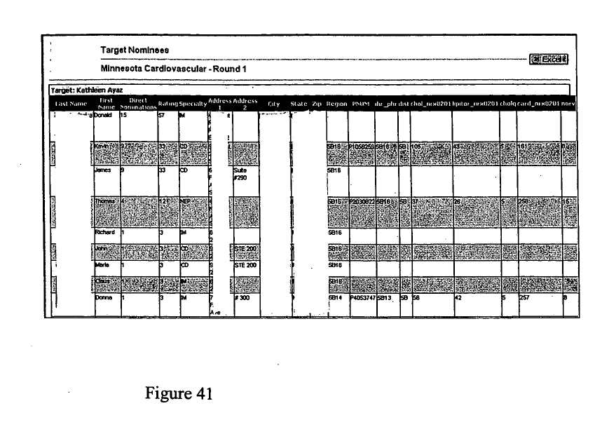

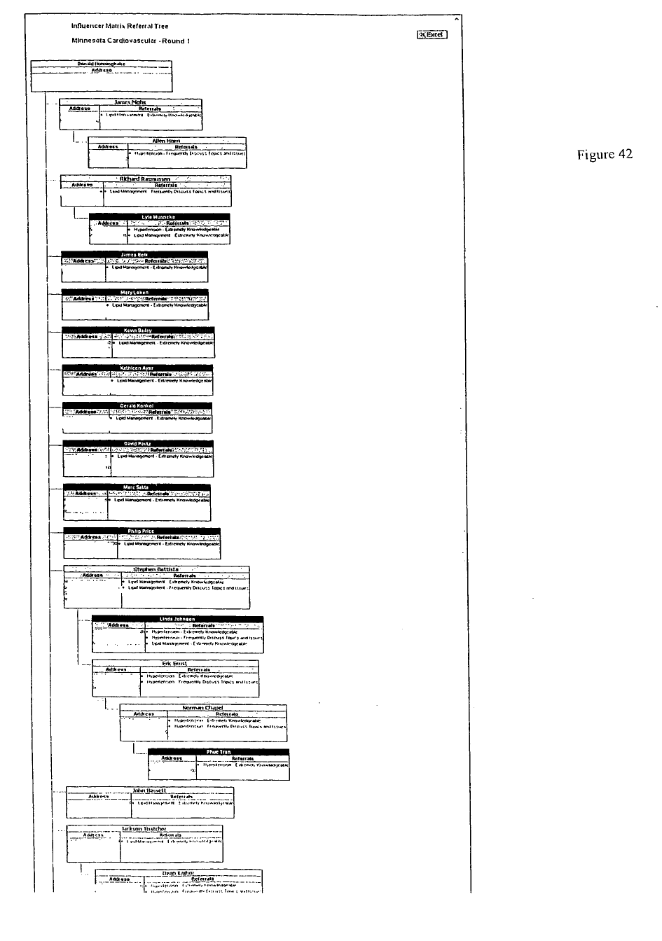

Additionally, surveys returned may be tracked from the influence matrix summary. Clicking surveys returned may generate a target mailing list of all physicians who returned a survey. The list may be ordered in any manner or appearance known to those skilled in the art, such as alphabetically by last name. Such a list is illustrated in FIG. 40. The selection of a target hyperlinked name may display the target nominee's window, as illustrated in FIG. 41. From this window, one may view the referral submitted by the selected target, according to their overall rating. The window of FIG. 41 may display all physicians nominated, or referred, by the selected target. It also may list information as discussed hereinabove, including total number of direct nominations, overall rating, specialty, contact information, and specific knowledge or demographic information supplied by the nominating target. In a manner similar to FIG. 39 hereinabove, selection of a name from the list of FIG. 41 may generate a referral tree, associated with that name, as illustrated in FIG. 42.

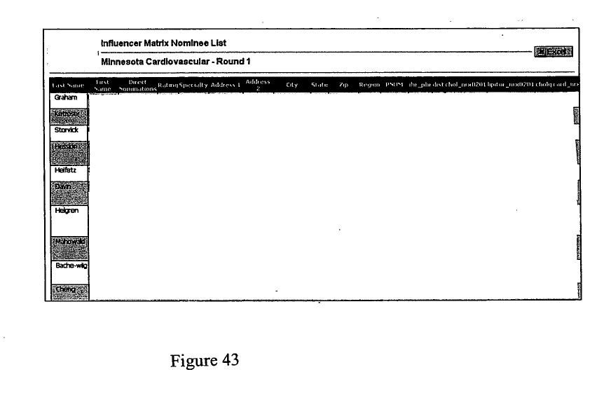

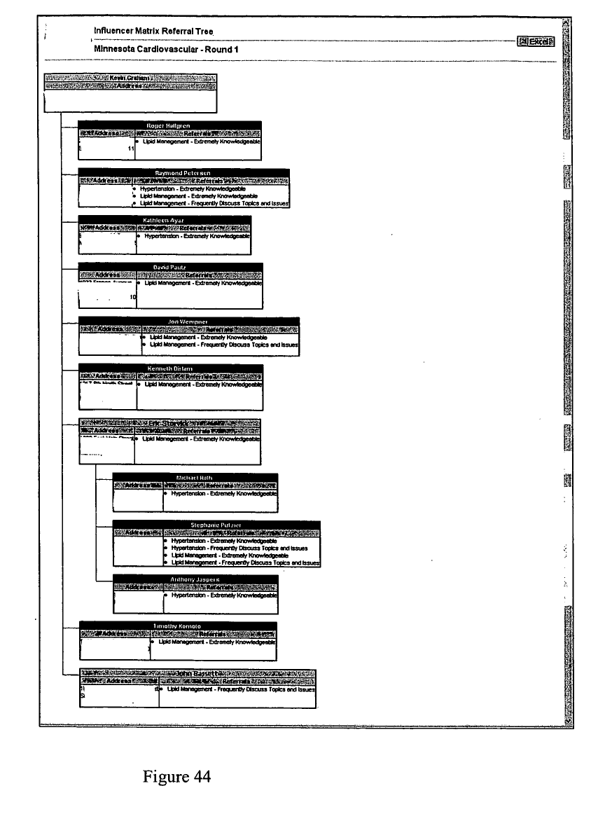

Nominees from the target list may also be viewed. The nominee list may display all nominated physicians who were on the original target list. The nominee list may be ordered by any methodology known to those skilled in the art, such as by the overall ranking of the nominee. An example of a nominee list is illustrated in FIG. 43. A hyperlinked nominee may be selected to view that nominee's relationship tree. Such a relationship tree is illustrated in FIG. 44.

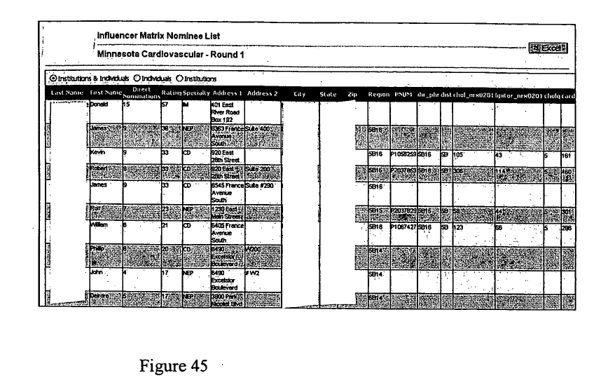

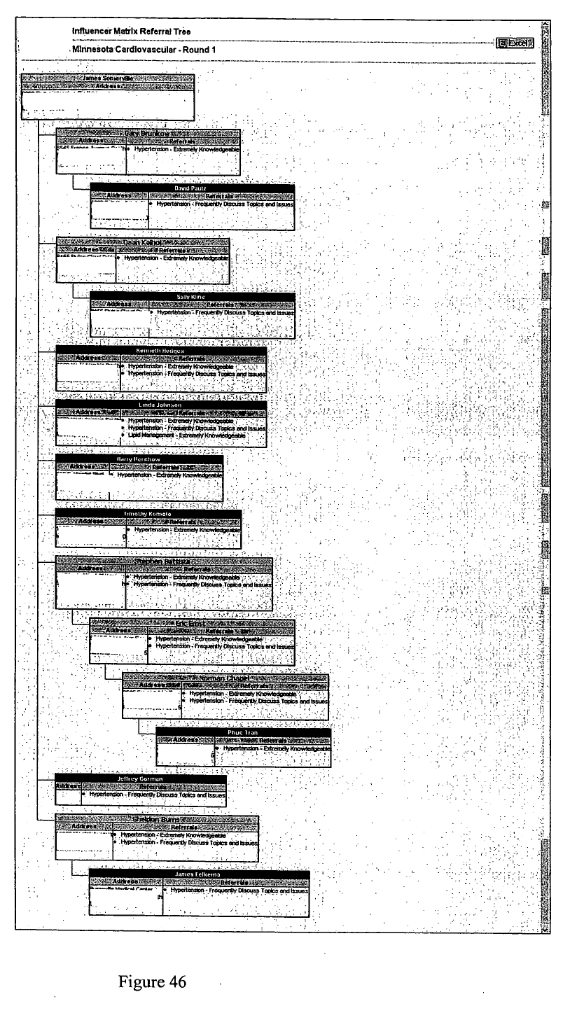

Further, unique nominees may be assessed through the use of the present invention. The unique nominee list may display all nominated physicians who were not included in the original target list. This list may be ordered by any methodology known to those skilled in the art, such as by the unique overall ranking of the nominee. A unique nominee list is illustrated in FIG. 45. The selection of a unique nominee from the window of FIG. 45 may generate the list of a referral tree for that unique nominee, as illustrated in FIG. 46.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A matrix associated with the influence of at least one participant, said matrix comprising:
at least one participant; and
a market defining the practice area of said at least one participant;
wherein said market is statistically modeled to represent the degree of influence exerted by said at least one participant.

2. The matrix of claim 1, wherein said market comprises physicians in a local pharmaceutical market.

3. The matrix of claim 1, wherein said statistical modeling results from answers to at least one question posed to a sampling of the market.

4. The matrix of claim 1, wherein said matrix is organized in a referral tree.

5. The matrix of claim 4, wherein said referral tree provides an accurate view of a local market.

6. The matrix of claim 1, wherein said at least one participant is identified based on multiple factors.

7. The matrix of claim 1, wherein said matrix is used as the basis for targeted marketing.

8. The matrix of claim 1, wherein said statistical modeling includes weighting factors suitable to provide an influence assessment.

9. The matrix of claim 1, wherein said statistical modeling identifies at least one key group of opinion leaders.

10. The matrix of claim 1, wherein said statistical modeling is based on at least two types of information.

11. The matrix of claim 10, wherein said at least two types of information include client supplied information and survey response information.

12. The matrix of claim 11, wherein said client supplied information is provided in response to at least one survey about frequently prescribing and targeted physicians and survey response information from targeted physicians regarding the perceptions of said targeted physicians.

13. The matrix of claim 11, wherein said survey is designed by a surveyor.

14. The matrix of claim 11, wherein said survey queries at least the numbers of prescriptions written by each physician.

15. The matrix of claim 11, wherein said survey queries at least the types of prescriptions written by each physician.

16. The matrix of claim 11, wherein the results of said survey are recorded in a relational database.

17. A method of assessing an influence level of at least one physician, comprising:
forwarding at least two survey questions to a physician, wherein one of said at least two survey questions includes an allowance for naming at least one nominee physician;
weighting at least one possible answer to the at least two survey questions;
receiving at least one response to said at least two survey question; and
placing the physician and the nominee physician in a referral tree at a hierarchical level in accordance with said weighting accorded the responses.

18. The method of claim 17, wherein said weighting comprises at least two types of information selected from the group consisting of client supplied information and survey response information.

19. The method of claim 17, wherein said receiving comprises assigning said weighting to the responses of the physician.

20. The method of claim 17, wherein said receiving comprises assigning of weight to the nominees name by the physician in the survey response.
